(19) United States
(12) Patent Application Publication
(10) Pub. No.: US 2025/0042426 A1
(43) Pub. Date: Feb. 6, 2025

(54) WARNING CONTROL DEVICE, WARNING CONTROL METHOD AND COMPUTER-READABLE STORAGE MEDIUM

(71) Applicant: HONDA MOTOR CO.,LTD., Tokyo (JP)

(72) Inventor: Yuta SAKAGAWA, Saitama (JP)

(21) Appl. No.: 18/774,946

(22) Filed: Jul. 17, 2024

(30) Foreign Application Priority Data
Jul. 31, 2023 (JP) 2023-124303

(51) Int. Cl. B60W 50/14; G08B 21/04; H04W 4/40

(52) U.S. Cl. CPC B60W 50/14; G08B 21/043; H04W 4/40

(57) ABSTRACT

A warning control device includes: a first acquiring unit that acquires first falling-down information indicating that a falling down of a user of a user terminal is sensed in the user terminal and location information of the user; and a warning control unit that performs a control for transmitting a warning to a vehicle around the user terminal, based on the first falling-down information, the location information of the user, and information indicating a location of a road, when it is determined that the user fell down on the road and a period of time in which the user is stopped on the road exceeds a predetermined period of time.

The contents of the following patent application(s) are incorporated herein by reference: NO. 2023-124303 filed in JP on Jul. 31, 2023.

### BACKGROUND

### 1. Technical Field

The present invention relates to a warning control device, a warning control method, and a computer-readable storage medium.

### 2. Related Art

In recent years, efforts have been intensified to provide access to a sustainable transportation system with consideration given to even vulnerable people among other traffic participants. To this end, research and development has been focused on to further improve traffic safety and convenience through research and development regarding a preventive safety technology. Patent document 1-3 describes a technology related to sensing of falling down of a pedestrian.

### PRIOR ART DOCUMENT

### Patent Document

Patent Document 1: WO 2019/044208
Patent document 2: Japanese Patent Application Publication No. 2021-179803
Patent document 3: Japanese Patent Application Publication No. 2020-181570

### BRIEF DESCRIPTION OF THE DRAWINGS

FIG. 1 schematically shows a usage scene of an assistance system 10.

FIG. 2 schematically shows a scene in which a user 80a fell down on a road.

FIG. 3 shows a functional configuration of an assistance apparatus 60.

FIG. 4 is a diagram related to roadway information generated by a roadway information generating unit 240.

FIG. 5 shows an example of an execution sequence of processes performed in a user terminal 82, an in-vehicle processing device 40 included in a vehicle 20, and the assistance apparatus 60.

FIG. 6 shows an example of an execution sequence of processes performed in an image capturing apparatus 70, the in-vehicle processing device 40, and the assistance apparatus 60.

FIG. 7 shows an example of the flowchart related to an assistance controlling method performed by the assistance apparatus 60.

FIG. 8 shows an example of a computer 2000.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are essential to the solution of the invention.

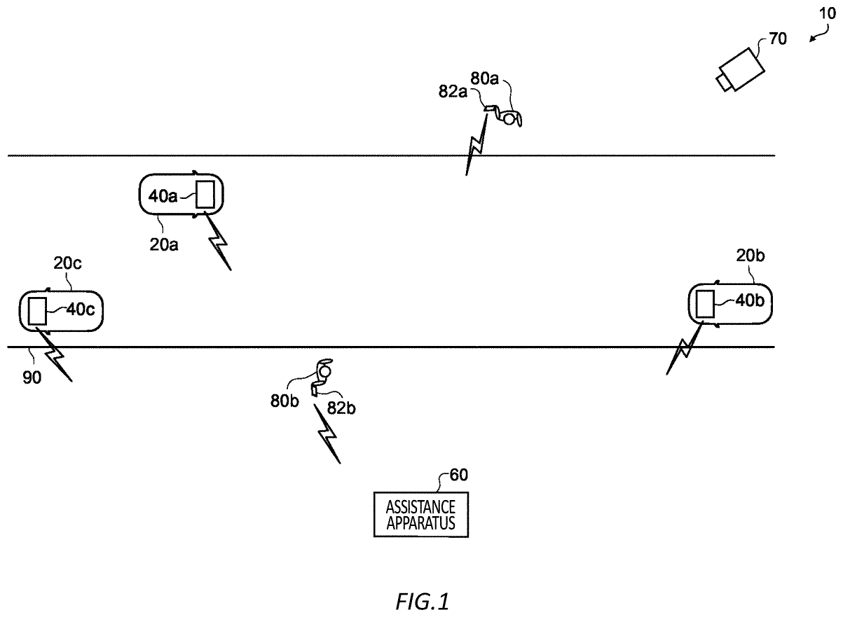

FIG. 1 schematically shows a usage scene of the assistance system 10. The assistance system 10 includes a vehicle 20a, a vehicle 20b, and a vehicle 20c, a user terminal 82a and a user terminal 82b, an assistance apparatus 60, and an image capturing apparatus 70.

The vehicle 20a includes an in-vehicle processing device 40a, the vehicle 20b includes an in-vehicle processing device 40b, and the vehicle 20c includes an in-vehicle processing device 40c.

The user terminal 82a is a terminal carried by the user 80a and the user terminal 82b is a terminal carried by the user 80b. In the present embodiment, the user 80a and the user 80b are pedestrians.

In this embodiment, the vehicle 20a, the vehicle 20b, and vehicle 20c may be collectively referred to as “vehicle 20”. The in-vehicle processing device 40a, the in-vehicle processing device 40b, and the in-vehicle processing device 40c may be collectively referred to as “in-vehicle processing device 40”. The user terminal 82a and the user terminal 82b are sometimes collectively referred to as “user terminal 82”. The user 80a and the user 80b are sometimes collectively referred to as “user 80”.

The vehicle 20 is a vehicle traveling on a road 90. The vehicle 20 is one example of a moving object. The in-vehicle processing device 40 is configured to include various types of sensors such as a location sensor including a global navigation satellite system (GNSS) receiver and a speed sensor such as a vehicle speed sensor. The in-vehicle processing device 40 includes a function for processing information acquired by the various types of sensors included in the in-vehicle processing device 40, and a function for communicating with the assistance apparatus 60. The in-vehicle processing device 40 provides an Advanced Driving Assistance System (ADAS) function which is equipped in the vehicle 20.

The user terminal 82 is a mobile terminal such as a smartphone, for example. The user terminal 82 is an example of the moving object. The user terminal 82 periodically transmits the current location information of the user terminal 82 that is detected by the location sensor included in the GNSS receiver to the assistance apparatus 60. The user terminal 82 has a function for sensing falling down of the user 80 based on information that is detected by an acceleration sensor and an angular velocity sensor included in the user terminal 82.

The image capturing apparatus 70 is an image capturing apparatus provided on a transportation infrastructure. The image capturing apparatus 70 acquires a location of each of the vehicle 20 and the user 80 existing within an image-capturing range of the image capturing apparatus 70 by analyzing an image that is captured, and transmits, to the assistance apparatus 60, the location of each of the vehicle 20 and the user 80 that is acquired.

The assistance apparatus 60 receives information transmitted from the in-vehicle processing device 40, the user terminal 82, and the image capturing apparatus 70 by mobile communication. The assistance apparatus 60 may receive information transmitted from the in-vehicle processing device 40 and the user terminal 82 through mobile communication as well as a communication line such as the Internet and a dedicated line.

The assistance apparatus 60 performs traffic assistance for the vehicle 20 based on the information received from the in-vehicle processing device 40, the user terminal 82, and the image capturing apparatus 70. The assistance apparatus 60 transmits a warning to the vehicle 20 when the user 80 falls down on the road.

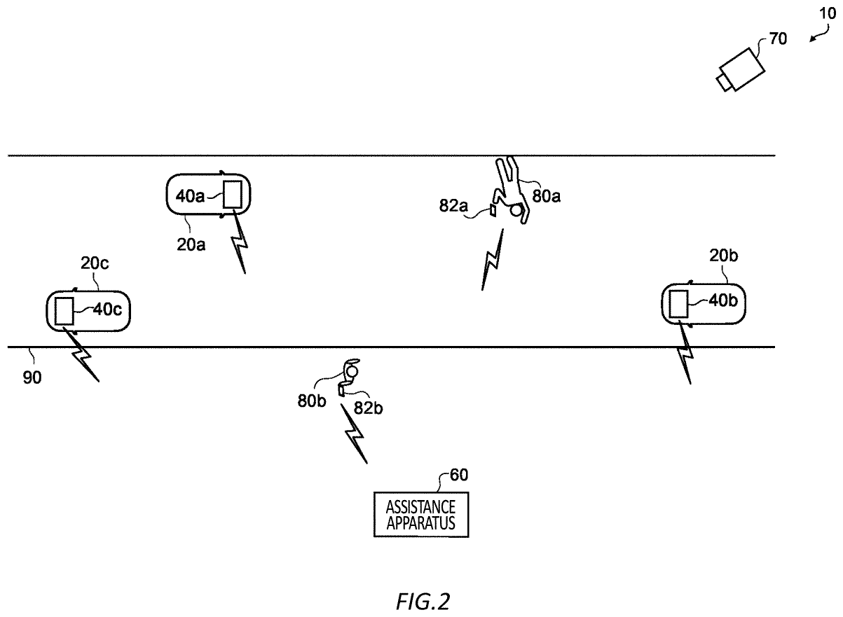

FIG. 2 schematically shows a scene in which the user 80a fell down on a road. When the user terminal 82a senses the falling down of the user 80a, the user terminal 82a transmits falling-down information indicating the falling down to the assistance apparatus 60. The user terminal 82a continues to periodically transmit the location information after sensing the falling down of the user 80a.

When receiving the falling-down information transmitted from the user terminal 82, the assistance apparatus 60 determines, based on the location information of the user terminal 82 that is transmitted from the user terminal 82 and road information indicating a location of the road, whether the location of the user terminal 82a at a time of sensing of the falling down by the user terminal 82a is on the road. If the location of the user terminal 82a at the time of the sensing of the falling down by the user terminal 82a is on the road, when it is determined that a displacement of the user terminal 82a does not occur within a predetermined period of time based on the location information of the user terminal 82a periodically transmitted from the user terminal 82a after sensing the falling down, the assistance apparatus 60 transmits a warning to the vehicle 20 located around the user terminal 82a.

When the image capturing apparatus 70 senses the falling down of the user 80a on the road 90 by analyzing the image that is captured by the image capturing apparatus 70, the image capturing apparatus 70 transmits, to the assistance apparatus 60, the falling-down information indicating the location at which the user 80a fell down. When it is determined that a displacement of the user 80a does not occur within a predetermined period of time based on the location information of the user 80a periodically transmitted from the image capturing apparatus 70 after the falling-down information is transmitted from the image capturing apparatus 70, the assistance apparatus 60 transmits a warning to the vehicle 20 that is located around the location indicated by the falling-down information received from the image capturing apparatus 70.

Although the falling down tends to frequently occur in the nighttime in general, the warning may not be appropriately transmitted to the vehicle 20 because the image capturing apparatus 70 may not sense the falling down of the user 80 with a high reliability in the nighttime. According to the assistance system 10, even if the image capturing apparatus 70 could not sense the falling down of the user 80, the warning can be appropriately transmitted to the vehicle 20 when the user 80 falls down based on the falling-down information sensed by the user terminal 82 and the location information of the user terminal 82. In this way, traffic safety can be improved.

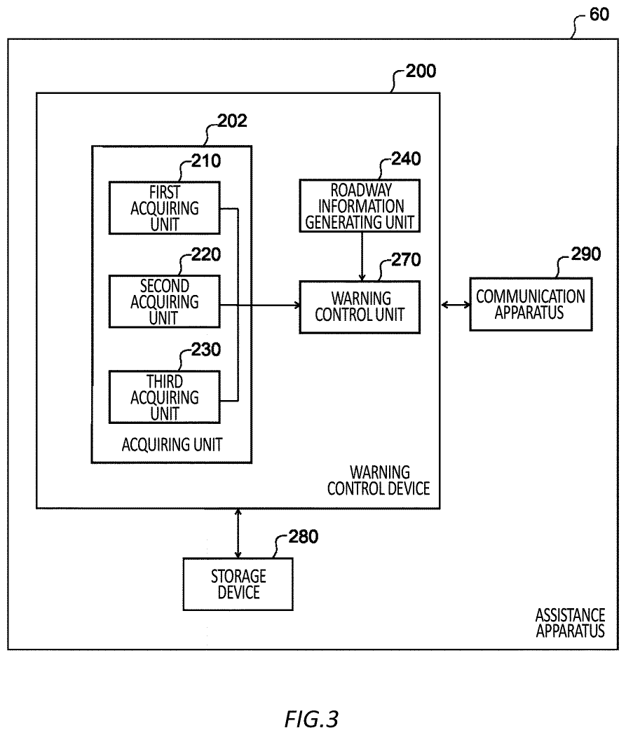

FIG. 3 shows a functional configuration of the assistance apparatus 60. The assistance apparatus 60 includes a warning control device 200, a communication apparatus 290, and a storage device 280.

The communication apparatus 290 provides for communication between each of the in-vehicle processing device 40 and the user terminal 82 and the assistance apparatus 60 based on a control of the warning control device 200. The warning control device 200 includes a circuit such as an arithmetic processing apparatus including a processor, for example. The warning control device 200 may be achieved by a microcomputer including a CPU, a ROM, a RAM, an I/O, a bus, and the like. The storage device 280 includes a non-volatile storage medium. The warning control device 200 performs a process by using information stored in the storage device 280.

The warning control device 200 includes an acquiring unit 202, a roadway information generating unit 240, and a warning control unit 270. The acquiring unit 202 includes a first acquiring unit 210, a second acquiring unit 220, and a third acquiring unit 230. Note that an embodiment in which the assistance apparatus 60 does not have some functions of the functional configuration shown in FIG. 3 may be adopted.

The first acquiring unit 210 acquires first falling-down information indicating that the falling down of the user 80 of the user terminal 82 is sensed in the user terminal 82, and location information of the user. The warning control unit 270 performs a control for transmitting a warning to the vehicle 20 around the user terminal 82 when it is determined that the user 80 fell down on a road and a period of time in which the user 80 is stopped on the road exceeds a predetermined period of time based on the first falling-down information, the location information of the user 80, and information indicating the location of the road.

The first acquiring unit 210 acquires the first falling-down information, and the location information of the user terminal 82 from the user terminal 82. The warning control unit 270 performs the control for transmitting the warning to the vehicle 20 around the user terminal 82 when the user terminal 82 is on a road at a time of sensing of the falling down of the user 80 and a period of time in which the user terminal 82 is on the road after the sensing of the falling down of the user in the user terminal 82 exceeds a predetermined period of time based on the first falling-down information, the location information of the user terminal 82, and the information indicating the location of the road.

The warning control unit 270 performs the control for transmitting the warning to the vehicle 20 around the user terminal 82 when a road is included within a predetermined range including a location of the user terminal 82 at a time of sensing of the falling down of the user 80 in the user terminal 82 and a period of time in which the road is included within the predetermined range including the location of the user terminal 82 after sensing of the falling down of the user 80 in the user terminal 82 exceeds a predetermined period of time.

The warning control unit 270 performs the control for transmitting the warning to the vehicle 20 around the user terminal 82 when the user terminal 82 is on a roadway at the time of sensing of the falling down of the user 80 and a period of time in which the user terminal 82 is on the roadway after the sensing of the falling down of the user in the user terminal 82 exceeds a predetermined period of time based on the first falling-down information, the location information of the user terminal 82, and the information indicating the location of the roadway on the road. The warning control unit 270 performs the control for transmitting the warning to the vehicle 20 around the user terminal 82 when it is determined that the user 80 fell down on a roadway and a period of time in which the user 80 is stopped on the roadway exceeds a predetermined period of time based on the first falling-down information, the location information of the user, and the information indicating the location of the roadway on the road.

The second acquiring unit 220 acquires a history of location information of a plurality of vehicles 20. The roadway information generating unit 240 generates information indicating a location of a roadway based on the history of the location information of the plurality of vehicles 20.

The third acquiring unit 230 acquires information indicating a history of location information of the user 80 and a location at which the user 80 fell down, which is detected by analyzing an image captured by the image capturing apparatus 70 provided around a road. The warning control unit 270 further performs the control for transmitting the warning to the vehicle 20 around the user 80 when it is determined that the location at which the user 80 fell down is on the road and a period of time in which the user 80 is stopped on the road exceeds a predetermined period of time based on the information acquired by the third acquiring unit 230 and the information indicating the location of the road.

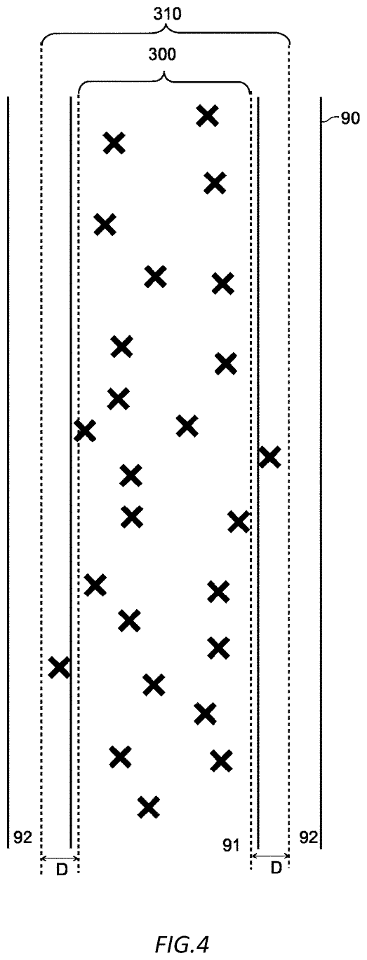

FIG. 4 is a diagram related to roadway information generated by a roadway information generating unit 240. In FIG. 4, a location of the vehicle 20 transmitted from the in-vehicle processing device 40 is plotted on the road 90 by a cross mark. Based on the history of the location of the vehicle 20 transmitted from the in-vehicle processing device 40, the roadway information generating unit 240 generates, as information indicating the location of the roadway, information indicating a range 300 in which a density of points at each of which the vehicle 20 that is traveling existed exceeds a predetermined value.

Based on the information indicating the range 300 generated by the roadway information generating unit 240, the warning control unit 270 determines that the user terminal 82 is located on the roadway when the range 300 exists within a predetermined distance D from the location of the user terminal 82. Specifically, the warning control unit 270 determines that the user terminal 82 is located on the roadway when the location of the user terminal 82 is within the range 310 of FIG. 4. The range 310 includes a part of sidewalks 92 provided on both sides of the roadway 91 of a real space. Therefore, it may be determined that the user terminal 82 is located on the roadway by the warning control unit 270 even if the location of the user terminal 82 detected by the user terminal 82 is located within the sidewalks 92 in the real space. Because an error is included in the location detected by the user terminal 82 based on a GNSS signal, even if the location detected by the user terminal 82 is located within the sidewalks 92 in the real space, the user terminal 82 may be actually located on the roadway 91 when the detected location is on a side that is closer to the roadway 91. Therefore, by setting the range 310 used for determining whether the user terminal 82 exists on the roadway to be wider than the range 300 determined as the roadway, safety can be improved.

As shown in FIG. 4, because the roadway information generating unit 240 generates information indicating the range 300 indicating the location of the roadway based on the location information of the vehicle 20, the warning control unit 270 can determine whether the user terminal 82 exists on the roadway by only determining whether the user terminal 82 exists within a portion through which the vehicle actually passes in the road.

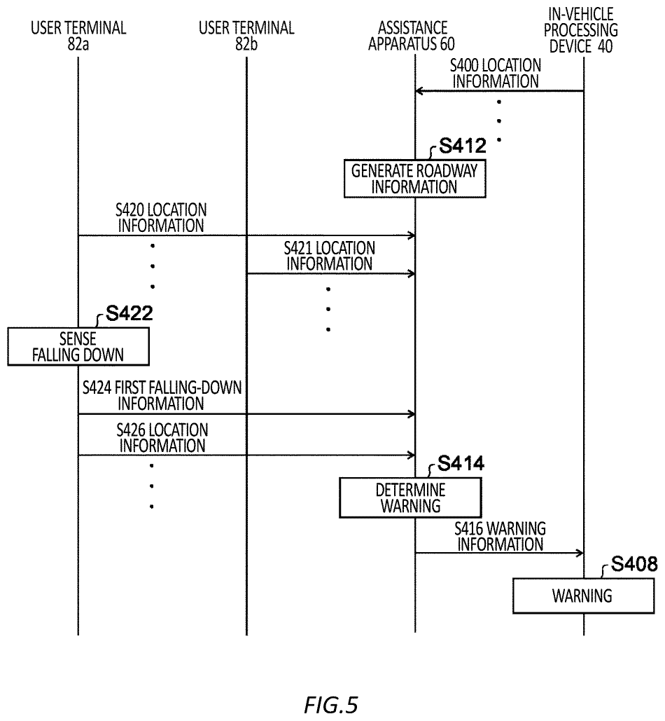

FIG. 5 shows an example of an execution sequence of processes performed in the user terminal 82, the in-vehicle processing device 40 included in the vehicle 20, and the assistance apparatus 60.

In S400, the in-vehicle processing device 40 periodically transmits location information of the vehicle 20 to the assistance apparatus 60. In S412, the roadway information generating unit 240 generates roadway information based on the location information of the vehicle 20. For example, the roadway information generating unit 240 generates information indicating the range 300 described in connection to FIG. 4 as information indicating a location of a roadway.

In S420, the user terminal 82a transmits location information indicating a current location of the user terminal 82a that is based on a signal received from the GNSS satellite to the assistance apparatus 60. The location information is periodically transmitted from the user terminal 82a to the assistance apparatus 60.

In S421, the user terminal 82b transmits location information indicating a current location of the user terminal 82b that is based on a signal received from the GNSS satellite to the assistance apparatus 60. The location information is periodically transmitted from the user terminal 82b to the assistance apparatus 60.

When the user terminal 82a senses the user 80a falling down by the user terminal 82a in S422, the user terminal 82a transmits first falling-down information to the assistance apparatus 60 in S424. After sensing the falling down of the user 80a by the user terminal 82a, the user terminal 82a also periodically transmits the location information of the user terminal 82a to the assistance apparatus 60.

In S414, the assistance apparatus 60 performs a process related to a warning related to the falling down. For example, the warning control unit 270 determines to perform a warning when the location of the user terminal 82a at a time of the falling down of the user 80a is on the roadway, and a period of time in which it is determined that the user terminal 82a does not move after the falling down of the user 80a exceeds a predetermined period of time based on a history of the location information transmitted from the user terminal 82a in S420 and S426, a time at which the first falling-down information is transmitted in S424, and information indicating the location of the roadway generated by the roadway information generating unit 240.

When the warning is determined to be performed, the warning control unit 270 transmits warning information for instructing the vehicle 20a and the vehicle 20b existing around the location of the user terminal 82a at the time of falling down of the user 80a and moving toward the location of the user terminal 82a at the time of falling down of the user 80a to output the warning through the communication apparatus 290, in S416. At this time, the warning control unit 270 may not transmit the warning information through the communication apparatus 290 to a vehicle 20c traveling in a direction away from the location of the user terminal 82a at the time of falling down of the user 80a.

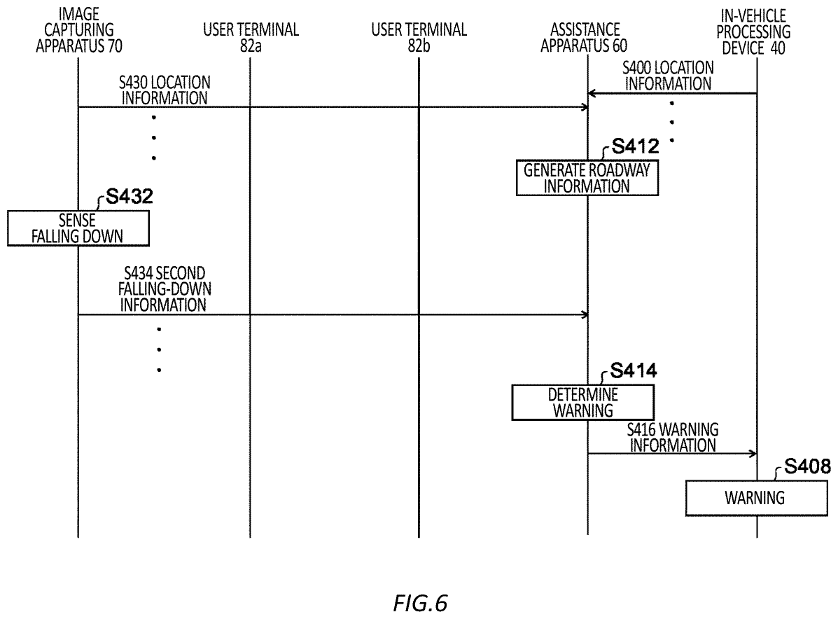

FIG. 6 shows an example of an execution sequence of processes performed in the image capturing apparatus 70, the in-vehicle processing device 40, and the assistance apparatus 60. FIG. 6 indicates an execution sequence of processes when the user terminal 82 does not have a function for sensing the falling down and a function for transmitting the location information. Here, a difference from the execution sequence of FIG. 5 is mainly described, and a description of the same process as the process in the execution sequence of FIG. 5 is omitted.

In S430, the image capturing apparatus 70 transmits the location information indicating the location of the user 80 and the location of the vehicle 20 obtained by analyzing an image captured by the image capturing apparatus 70 to the assistance apparatus 60. In S412, the roadway information generating unit 240 generates roadway information based on the location information of the vehicle 20 transmitted from the in-vehicle processing device 40, and the location information of the vehicle 20 transmitted from the image capturing apparatus 70.

In S432, upon detecting the falling down of the user 80a by analyzing the image by the image capturing apparatus 70, in S434, the image capturing apparatus 70 transmits second falling-down information to the assistance apparatus 60. The second falling-down information includes information indicating the location of the user 80a at a time of detecting the falling down of the user 80a, and information indicating the location of the user 80a detected after detecting the falling down of the user 80a. Information indicating the location of the user 80a after detecting the falling down of the user 80a is periodically transmitted.

In S414, the assistance apparatus 60 performs a process related to a warning related to the falling down. For example, the warning control unit 270 determines to perform a warning when the location of the user 80a at a time of the falling down of the user 80a is on the roadway, and a period of time in which it is determined that the user 80a does not move after the falling down of the user 80a exceeds a predetermined period of time, based on the second falling-down information transmitted from the image capturing apparatus 70 in S434, a time at which the second falling-down information initially received in S434, and information indicating the location of the roadway generated by the roadway information generating unit 240.

When the warning is determined to be performed, the warning control unit 270 transmits warning information for instructing the vehicle 20a and the vehicle 20b existing around the location of the user terminal 80a at the time of falling down of the user 80 and moving toward the location of the user terminal 80a at the time of falling down of the user 80a to output the warning through the communication apparatus 290, in S416. At this time, the warning control unit 270 may not transmit the warning information through the communication apparatus 290 to a vehicle 20c traveling in a direction away from the location of the user terminal 82a at a time of falling down of the user 80a.

The embodiment in which the assistance apparatus 60 receives information related to the falling down detected in the user terminal 82 is described in connection to FIG. 5, and the embodiment in which the assistance apparatus 60 receives information related to the falling down detected in the image capturing apparatus 70 is described in connection to FIG. 6. As another embodiment, an embodiment combining the process related to FIG. 5 and the process related to FIG. 6 may be adopted. For example, the assistance apparatus 60 may receive the first falling-down information from the user terminal 82, and then perform a process related to the warning based on a history of the location information of the user 80a included in the second falling-down information transmitted from the image capturing apparatus 70. As another example, the assistance apparatus 60 may receive the second falling-down information from the image capturing apparatus 70, and then perform a process related to the warning based on a history of the location information of the user terminal 82a transmitted from the user terminal 82a.

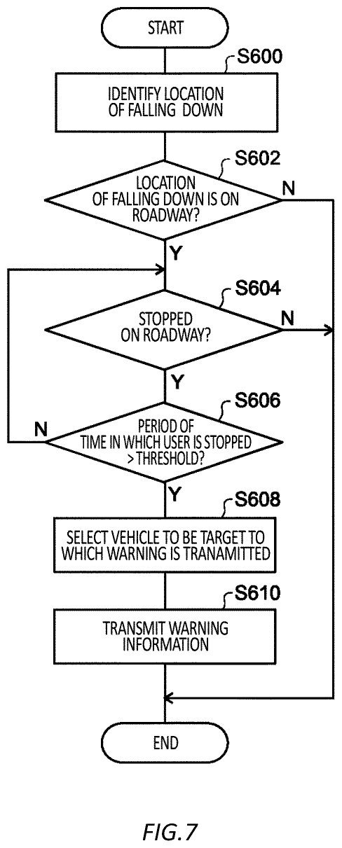

FIG. 7 shows an example of the flowchart related to an assistance controlling method performed by the assistance apparatus 60. The process in this flowchart may be repeatedly performed. Here, the process related to an embodiment in which the assistance apparatus 60 receives information that is detected in the user terminal 82 is described, but a similar process can be applied for an embodiment in which information detected in the image capturing apparatus 70 is received. The process in this flowchart is started when the first falling-down information is received from the user terminal 82.

In S600, the warning control unit 270 identifies a location at which the user 80 fell down based on a time at which the first falling-down information acquired by the first acquiring unit 202 is received, and a history of the location information received from the user terminal 82. The warning control unit 270 identifies the location of the user terminal 82 when the falling down is sensed in the user terminal 82 as a location at which the user 80 fell down.

In S602, the warning control unit 270 determines whether the location at which the user 80 fell down is on the roadway. The warning control unit 270 determines whether the location at which the user 80 fell down is on the roadway based on the information indicating the location of the roadway generated by the roadway information generating unit 240, and the location at which the user 80a fell down identified in S602. When it is determined that the location at which the user 80 fell down is not on the roadway, the process in this flowchart ends.

When it is determined that the location at which the user 80 fell down is on the roadway in S602, the warning control unit 270 determines, in S604, whether the user 80 is stopped on the roadway after the user 80 fell down. For example, based on the history of the location information of the user terminal 82 after the user 80 fell down, the warning control unit 270 determines that the user 80 is stopped on the roadway, when the location of the user 80 after the user 80 fell down does not change on the roadway. When it is determined that the user 80 is not stopped on the roadway after the user 80 fell down, the process of this flowchart ends.

When it is determined that the user 80 is stopped on the roadway after the user 80 fell down in S604, it is determined, in S606, whether a period of time in which the user 80 is stopped on the roadway after the user 80 fell down exceeds a threshold. When the period of time in which the user 80 is stopped on the roadway after the user 80 fell down does not exceed the threshold, the process proceeds to S604.

When it is determined that the period of time in which the user 80 is stopped on the roadway after the user 80 fell down in S606 exceeds a threshold, the warning control unit 270 selects, in S608, a vehicle 20 to be a target to which a warning is transmitted. For example, based on the location information of the vehicle 20, the warning control unit 270 may select a vehicle 20 located within the predetermined range including the location at which the user 80 fell down as a vehicle 20 to be a target to which a warning is transmitted. Based on the location information of the vehicle 20, the warning control unit 270 may select a vehicle 20 moving toward the location at which the user 80 fell down as a vehicle 20 to be a target to which a warning is transmitted.

In S610, the warning control unit 270 transmits warning information for instructing the vehicle 20 selected in S608 to output the warning.

In the above description, the embodiment in which the warning control unit 270 determines whether the location of the user 80 and/or the user terminal 82 at a time of falling down of the user 80 and after the user 80 fell down is on the roadway and the transmits warning information is mainly described. However, the embodiment in which the warning control unit 270 determines whether the location of the user 80 and/or the user terminal 82 at a time of falling down of the user 80 and after the user 80 fell down is on the road and the transmits warning information may be adopted. In this embodiment, the warning control unit 270 may determine whether the location of the user 80 and/or the user terminal 82 is on the road based on map information indicating the location of the road and location information of the user 80 and/or the user terminal 82.

According to the assistance system 10 described above, based on the falling-down information sensed by the user terminal 82 and the location information of the user 80, when the user 80 falls down on the road and the user 80 is stopped on the road for a predetermined period of time after falling down, the warning can be transmitted to the vehicle 20. In this way, even if the image capturing apparatus 70 installed in the transportation infrastructure cannot sense the falling down of the user 80, the warning can be transmitted to the vehicle 20 at an appropriate time.

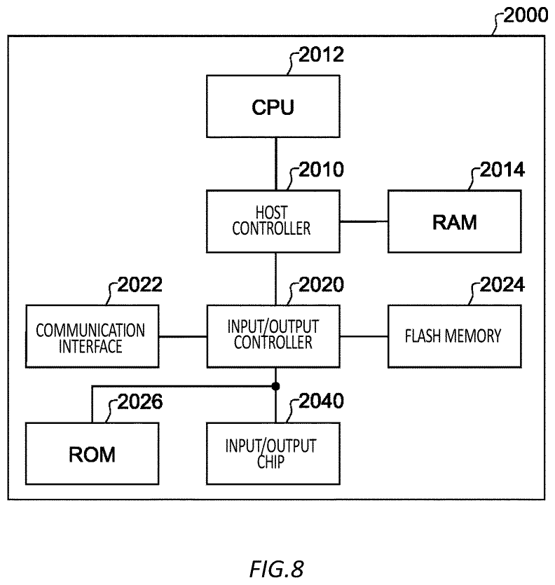

FIG. 8 shows an example of a computer 2000 where a plurality of embodiments of the present invention may be entirely or partially embodied. A program installed on the computer 2000 can cause the computer 2000 to: function as an apparatus such as the assistance apparatus 60 according to the embodiment or each unit of the apparatus; perform an operation associated with the apparatus or each unit of the apparatus; and/or perform the process according to the embodiment or a step of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be actualized by executing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

A program that is installed on the computer 2000 and causes the computer 2000 to function as the assistance apparatus 60 may instruct CPU 2012 or the like to cause the computer 2000 to respectively function as each unit of the assistance apparatus 60 (for example, the warning control device 200 or the like). The information processing described in these programs are read into the computer 2000, and thereby function as each unit of the assistance apparatus 60 that are specific means in which the software and various types of hardware resources described above are cooperating. These specific means implement operations or processing of information according to the intended use of the computer 2000 in the present embodiment, and the assistance apparatus 60 is thereby constructed to be specific for the intended use.

Various embodiments have been described with reference to the block diagrams and the like. In the block diagrams, each block may represent (1) a stage of a process in which an operation is executed, or (2) components of the apparatus having a role in executing the operation. A specific stage and component may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from description of the claims that the embodiments to which such alterations or improvements are made can be included in the technical scope of the present invention.

Each process of the operations, procedures, steps, and stages etc. in the apparatus, system, program, and method shown in the claims, specification, or diagrams can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or diagrams, it does not necessarily mean that the process must be performed in this order.

### EXPLANATION OF REFERENCES

10 assistance system;
20 vehicle;
40 in-vehicle processing device;
60 assistance apparatus;
70 image capturing apparatus;
80 user;
82 user terminal;
90 road;
91 roadway;
92 sidewalk;
200 warning control device;
202 acquiring unit;
210 first acquiring unit;
220 second acquiring unit;
230 third acquiring unit;
240 roadway information generating unit;
270 warning control unit;
280 storage device;
290 communication apparatus;
300, 310 range;
2000: computer;
2010: host controller;
2012 CPU;
2014 RAM;
2020: input/output controller;
2022: communication interface;
2024: flash memory;
2026 ROM;
2040: input/output chip.

What is claimed is:

1. A warning control device comprising:
a first acquiring unit that acquires first falling-down information indicating that a falling down of a user of a user terminal is sensed in the user terminal and location information of the user; and
a warning control unit that performs a control for transmitting a warning to a vehicle around the user terminal when it is determined that the user fell down on the road and a period of time in which the user is stopped on the road exceeds a predetermined period of time based on the first falling-down information, the location information of the user, and information indicating a location of a road.

2. The warning control device according to claim 1, wherein
the first acquiring unit acquires the first falling-down information and the location information of the user terminal from the user terminal,
the warning control unit performs the control for transmitting the warning to the vehicle around the user terminal when it is determined that the user terminal is on the road at a time of sensing of the falling down of the user and a period of time in which the user terminal is on the road after the sensing of the falling down of the user in the user terminal exceeds a predetermined period of time based on the first falling-down information, the location information of the user terminal, and the information indicating the location of the road.

3. The warning control device according to claim 2, wherein
the warning control unit performs the control for transmitting the warning to the vehicle around the user terminal when it is determined that the road is included within a predetermined range including a location of the user terminal at the time of sensing of the falling down of the user in the user terminal and a period of time in which the road is included within the predetermined range including the location of the user terminal after the sensing of the falling down of the user in the user terminal exceeds a predetermined period of time.

4. The warning control device according to claim 2, wherein
the warning control unit performs the control for transmitting the warning to the vehicle around the user terminal when it is determined that the user terminal is on a roadway at the time of sensing of the falling down of the user and a period of time in which the user terminal is on the roadway after the sensing of the falling down of the user in the user terminal exceeds a predetermined period of time based on the first falling-down information, the location information of the user terminal, and the information indicating the location of the roadway on the road.

5. The warning control device according to claim 1, wherein
the warning control unit performs the control for transmitting the warning to the vehicle around the user terminal when it is determined that the user fell down on a roadway and a period of time in which the user is stopped on the roadway exceeds a predetermined period of time based on the first falling-down information, the location information of the user, and the information indicating the location of the roadway on the road.

6. The warning control device according to claim 4, further comprising:
a second acquiring unit that acquires a history of location information of a plurality of vehicles; and
a roadway information generating unit that generates information indicating the location of the roadway based on the history of the location information of the plurality of vehicles.

7. The warning control device according to claim 1, further comprising
a third acquiring unit that acquires information indicating a history of the location information of the user and a location at which the user fell down, which is detected by analyzing an image captured by an image capturing apparatus provided around the road, wherein
the warning control unit further performs a control for transmitting a warning to a vehicle around the user when it is determined that the location at which the user fell down is on the road and a period of time in which the user is stopped on the road exceeds a predetermined period of time based on the information acquired by the third acquiring unit and the information indicating the location of the road.

8. The warning control device according to claim 5, further comprising:
a second acquiring unit that acquires a history of location information of a plurality of vehicles; and
a roadway information generating unit that generates information indicating the location of the roadway based on the history of the location information of the plurality of vehicles.

9. The warning control device according to claim 2, further comprising
a third acquiring unit that acquires information indicating a history of the location information of the user and a location at which the user fell down, which is detected by analyzing an image captured by an image capturing apparatus provided around the road, wherein
the warning control unit further performs the control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

10. The warning control device according to claim 3, further comprising
a third acquiring unit that acquires information indicating a history of the location information of the user and a location at which the user fell down, which is detected by analyzing an image captured by an image capturing apparatus provided around the road, wherein
the warning control unit further performs the control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

11. The warning control device according to claim 4, further comprising
a third acquiring unit that acquires information indicating a history of the location information of the user and a location at which the user fell down, which is detected by analyzing an image captured by an image capturing apparatus provided around the road, wherein
the warning control unit further performs the control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

12. The warning control device according to claim 5, further comprising
a third acquiring unit that acquires information indicating a history of the location information of the user and a location at which the user fell down, which is detected by analyzing an image captured by an image capturing apparatus provided around the road, wherein
the warning control unit further performs the control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

13. The warning control device according to claim 6, further comprising
a third acquiring unit that acquires information indicating a history of the location information of the user and a location at which the user fell down, which is detected by analyzing an image captured by an image capturing apparatus provided around the road, wherein
the warning control unit further performs control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

14. The warning control device according to claim 8, further comprising
a third acquiring unit that acquires information indicating a history of the location information of the user and a location at which the user fell down, which is detected by analyzing an image captured by an image capturing apparatus provided around the road, wherein
the warning control unit further performs the control for transmitting the warning to the vehicle around the user when it is determined that the location at which the user fell down is on the road and a period of time in which the user is stopped on the road exceeds a predetermined period of time based on the information acquired by the third acquiring unit and the information indicating the location of the road.

15. The warning control device according to claim 1, wherein
the warning control unit performs a control for transmitting a warning to a vehicle existing around the location of the user terminal and moving toward the location of the user terminal at a time of sensing of the falling down of the user, based on the first falling-down information, the location information of the user, and information indicating a location of a road, when it is determined that the user fell down on the road and a period of time in which the user is stopped on the road exceeds a predetermined period of time.

16. The warning control device according to claim 2, wherein
the warning control unit performs a control for transmitting a warning to a vehicle existing around the location of the user terminal and moving toward the location of the user terminal at the time of sensing of the falling down of the user, based on the first falling-down information, the location information of the user terminal, and the information indicating the location of the road, when it is determined that the user terminal is on the road at the time of sensing of the falling down of the user and a period of time in which the user terminal is on the road after the sensing of the falling down of the user in the user terminal exceeds a predetermined period of time.

17. The warning control device according to claim 3, wherein
the warning control unit performs a control for transmitting a warning to a vehicle existing around the location of the user terminal and moving toward the location of the user terminal at the time of sensing of the falling down of the user, when it is determined that the road is included within the predetermined range including a location of the user terminal at the time of sensing of the falling down of the user in the user terminal, and a period of time in which the road is included within the predetermined range including the location of the user terminal after the sensing the falling down of the user in the user terminal exceeds a predetermined period of time.

18. The warning control device according to claim 4, wherein
the warning control unit performs a control for transmitting a warning to a vehicle existing around the location of the user terminal and moving toward the location of the user terminal at the time of sensing of the falling down of the user, based on the first falling-down information, the location information of the user terminal, and information indicating a location of a roadway on a road, when it is determined that the user terminal is on the roadway at the time of sensing of the falling down of the user and a period of time in which the user terminal is on the roadway after the sensing of the falling down of the user in the user terminal exceeds a predetermined period of time.

19. A warning control method comprising:
acquiring first falling-down information indicating that a falling down of a user of a user terminal is sensed in the user terminal and location information of the user; and
performing a control for transmitting a warning to a vehicle around the user terminal when it is determined that the user fell down on the road and a period of time in which the user is stopped on the road exceeds a predetermined period of time based on the first falling-down information, the location information of the user, and information indicating a location of a road.

20. A non-transitory computer-readable storage medium having a program stored thereon, the program causes a computer to function as:
a first acquiring unit that acquires first falling-down information indicating that a falling down of a user of a user terminal is sensed in the user terminal and location information of the user; and
a warning control unit that performs a control for transmitting a warning to a vehicle around the user terminal, based on the first falling-down information, the location information of the user and information indicating a location of a road, when it is determined that the user fell down on the road and a period of time in which the user is stopped on the road exceeds a predetermined period of time.
